(19) United States
(12) Patent Application Publication
(10) Pub. No.: US 2008/0222699 A1
(43) Pub. Date: Sep. 11, 2008

(54) System and Method for Extensible Lobby Services

(76) Inventor: Barry Sohl, Huntington Beach, CA (US)

Correspondence Address: TOWNSEND AND TOWNSEND AND CREW LLP/EA, TWO EMBARCADERO CENTER, 8TH FLOOR, SAN FRANCISCO, CA, 94111, US

(21) Appl. No.: 11/682,855

(22) Filed: Mar. 6, 2007

(51) Int. Cl. H04L 9/32

(52) U.S. Cl. 726/2

(57) ABSTRACT

A server comprising a transceiver configured to support communications from a user terminal and a processor configured to maintain a virtual lobby having one or more variables associated therewith, the processor being further configured to receive from the user terminal one or more variables, and allow the user terminal access to the virtual lobby if each of the one or more variables received from the user terminal match the one or more variables associated with the virtual lobby.

### BACKGROUND

1. Field

The present disclosure relates generally to communications devices, and more particularly, to the operation of an extensible lobby services system on communications devices.

2. Background

Much as a hotel lobby is the first point of entry for its guests, the notion of a ‘virtual lobby’ can analogously apply in much the same fashion in the computer world. A virtual lobby, though physically non-existent, is simply a conjectural central repository where users wishing to share a common application can interact with each other. Similarly, a virtual room is conceptually identical to a room, as it exists in a hotel where one must first enter the hotel lobby before continuing to an assigned room meeting their needs.

The concept behind virtual lobbies and virtual rooms have, thus far, mainly existed in the realm of individual applications running on individual platforms, e.g., console-based games. Traditionally, lobby services, have not been portable across a varying spectrum of applications. In a mobile communications device environment, it becomes exceedingly important to implement an extensible lobby services system designed to provide highly efficient and highly configurable lobby services to any application developer wishing to take advantage of this system.

The inherent limitations among existing systems offering limited lobby services result in the inefficient re-creation and redesign of lobby services for each application. Thus, there is a need for a system that provides communications devices the ability to offer extensible lobby services while remaining wholly agnostic to the applications wanting to avail themselves of the services offered.

### SUMMARY

One aspect of a server is disclosed. A server includes a transceiver configured to support communications from a user terminal and a processor configured to maintain a virtual lobby having one or more variables associated therewith, the processor being further configured to receive from the user terminal one or more variables, and allow the user terminal access to the virtual lobby if each of the one or more variables received from the user terminal match the one or more variables associated with the virtual lobby.

One aspect of a method for matching users based on at least one of a plurality of configurable variables is also disclosed. The method includes maintaining a virtual lobby having one or more variables associated therewith, receiving from a user terminal one or more variables, and allowing the user terminal access to the virtual lobby if the one or more variables received from the user terminal match the one or more variables associated with the virtual lobby.

Another aspect of a server is disclosed. The server includes a means for communicating with a user terminal, means for maintaining a virtual lobby having one or more variables associated therewith, means for receiving from the user terminal one or more variables, and means for allowing a user terminal access to the virtual lobby if the one or more variables received from the user terminal match the one or more variables associated with the virtual lobby.

An aspect of a computer readable medium is disclosed. A computer readable medium embodying a program of instructions executable by a processor, the instructions including code to maintain a virtual lobby, and allow the user terminal access to the virtual lobby if the one or more variables received from the user terminal matches one or more variables associated with the virtual lobby.

### BRIEF DESCRIPTION OF DRAWINGS

Aspects of the present invention are illustrated by way of example, and not by way of limitation, in the accompanying drawings wherein:

FIG. 1 is a conceptual block diagram illustrating a how a group of user terminals would abstractly interact with a server providing extensible lobby services;

FIG. 2 is an example of a hardware configuration for the software-based extensible lobby services system;

FIG. 3 is a conceptual block diagram illustrating the logical layout of virtual lobbies and their interrelation with virtual rooms and applications; and

FIG. 4 is a flow chart of an illustrative embodiment of an extensible lobby services system.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well-known structures and components are shown in block diagram form in order to avoid obscuring the concepts of the invention.

The various concepts described throughout this disclosure may be applied to any group of user terminals in a communications system. The user terminals may be any combination of desktop computers, laptop computers, client workstations, server-enabled computers, dedicated servers, mainframes, mobile telephones, personal digital assistants (PDAs), games consoles, or other suitable nodes. In the following detailed description, these concepts will be described in the context of a server and one or more user terminals configured to interact with each other in order to provide extensible lobby services across multiple applications. As those skilled in the art will recognize, these concepts can be extended to many differing applications. Indeed, the extensible lobby services system is strictly application agnostic, yet the system is extensible and flexible enough to mimic an operating environment where the lobby services were dedicated to just one particular application and thus, transparent to the end-user.

The extensible lobby services system handles all functionality related to matching users together so that they may participate and interact with a common application of their choice. One of ordinary skill in the art would appreciate that the extensible lobby services system is a powerful and feature rich system that is flexible enough to accommodate most application designs. The extensible lobby services system relies heavily on the concept of key sets—that are used to define the variables of rooms and users within a virtual lobby or virtual room.

A virtual lobby or virtual room, as used herein, is a collection of users interacting with each other through user terminals and a whole host of applications made available to them by a server. Each user may interact with one or more applications, and one or more user terminals may interact with each application. Users may be able to create, join, leave, and begin interactive applications and they may be able to see which applications are readily available and which users are in a virtual room.

The variables associated with virtual lobbies and virtual rooms are comprised of key sets, or simply, keys, having metadata and runtime values associated with them. Metadata is the data describing the key itself and remains fixed for all instances of a key. This allows keys to be copied without having to copy the metadata each time, and allows keys to be efficiently sent across a communications network, especially where byte count is at a premium. All key metadata is read-only. Key metadata is defined in a server-side XML file. The following are sample key metadata fields: key type (numeric, text, Boolean, enumeration, etc.), key name, optional default value, optional fixed value, optional min/max range, and enumeration labels.

All keys can also have a runtime value. This is the actual value that you set for the key while your application is running. Validation of key runtime values across the communications network is automatically handled by API services. Runtime values are obtainable from the user terminal or the server side, depending on the type of key. Server side keys are set by the lobby services server administrator and are base keys. Base keys are common to all applications interacting with the server's extensible lobby services and cannot be manipulated by a user. However, a user can set his or her own runtime value of an enhanced key using any standard user interface to input values.

Some key types can also have a key modifier, which modifies the meaning of the runtime value. Some available modifiers, for example, are: include, exclude, greater than, less than, equals, and wild card. The modifiers allow basic query logic when using a key set with API search methods. If no modifiers are specified, the key will be Include and Equals by default. By way of example, key set values could be used to search for “all male users over the age of 40 without gray hair”—thus, one skilled in the art can take advantage of the granular and endless possibilities offered by the extensible lobby services and provide application developers with unprecedented ability to engineer a matching service for users based on a multitude of variables. The wildcard modifier is valid for text keys only and allows for wildcard text searches. When the wildcard modifier is enabled, the wildcard character “*” can be used to represent a wildcard within the search string. The wildcard character can be placed at either the beginning of the comparison string, the end of the comparison string, or both. This allows you to provide “starts with,” “ends with,” or “contains” functionality in your text key searches.

Key sets, and their underlying keys, are defined in a server-side XML file. The file uses standard XML formatting and validation. The server defines the set of base keys in its own internal file. This file can only be modified by a user with the appropriate security access. However, an individual application developer can create their own application specific keys as well. With these specific keys, one skilled in the art can override the definition of base keys and can, additionally, define their own keys.

Currently, several robust game platforms provide application agnostic lobby services but neither offers the extensibility of a lobby services system that a user or developer can modify by changing or adding key sets, base and enhanced. For example, if a game, or other suitable application, wants to do matching based on a user's hair color, eye color, or other indiscriminate variable, unless that is a feature supported by the library, current game platforms would not be able to support it without having to modify the library itself. The extensible lobby services system circumvents this limitation and easily allows extensibility in endless combinations without as much as a rebuild.

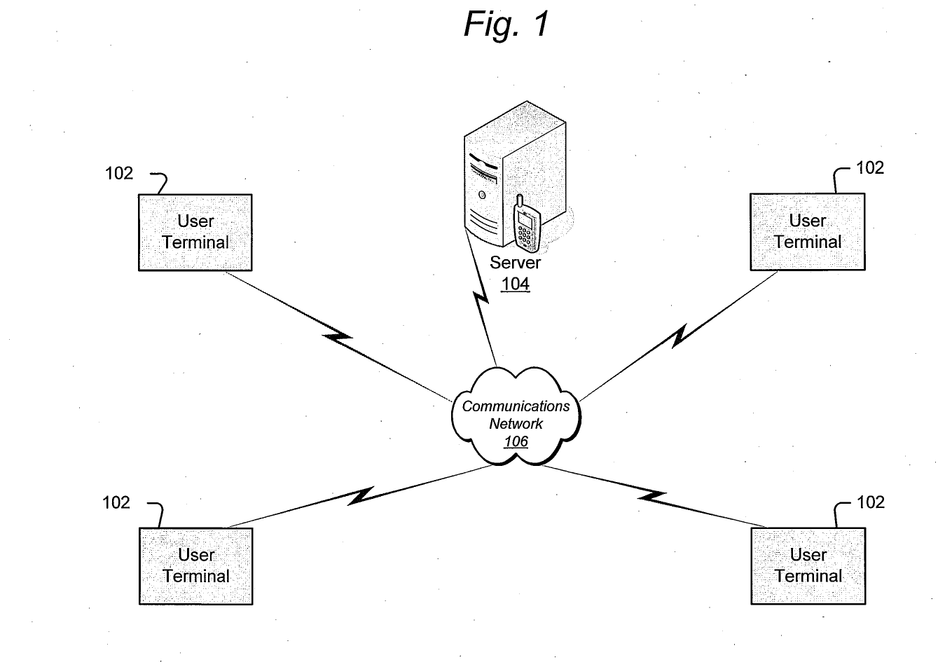

FIG. 1 is a conceptual block diagram illustrating a how a group of user terminals would abstractly interact with a server providing extensible lobby services. One or more user terminals 102 would transmit over a communications network 106 the variables associated to each respective user terminal 102. These variables are then received by the server 104 that maintains the extensible lobby services API. A single extensible lobby services API may be running on the server 104, however, the API can be customized for each and every application wishing to participate by editing an XML file. This eliminates the need to, inter alia, create a separate library, separate API, and writing custom code.

In one exemplary embodiment of an extensible lobby services system, a user terminal 102 may wish to cooperatively engage in the use of a common application, e.g. a game, with a peer user terminal 102. A facilitating server 104 provides the common extensible lobby services API within which each respective user terminal 102 can communicate with over a communications network 106. For example, a user, via a user terminal 102, may decide to play Poker in a multi-player environment. The server 104 will take the users request and place the logical connection into a virtual lobby dedicated to users wishing to play Poker. From within the virtual lobby, the user may search for players meeting a set of particular variables, e.g., keeping with the Poker hypothetical-minimum bet of five and maximum of ten. The server 104 may then present the user with virtual rooms meeting the search criteria and allow the user terminal 102 access to those individual virtual rooms.

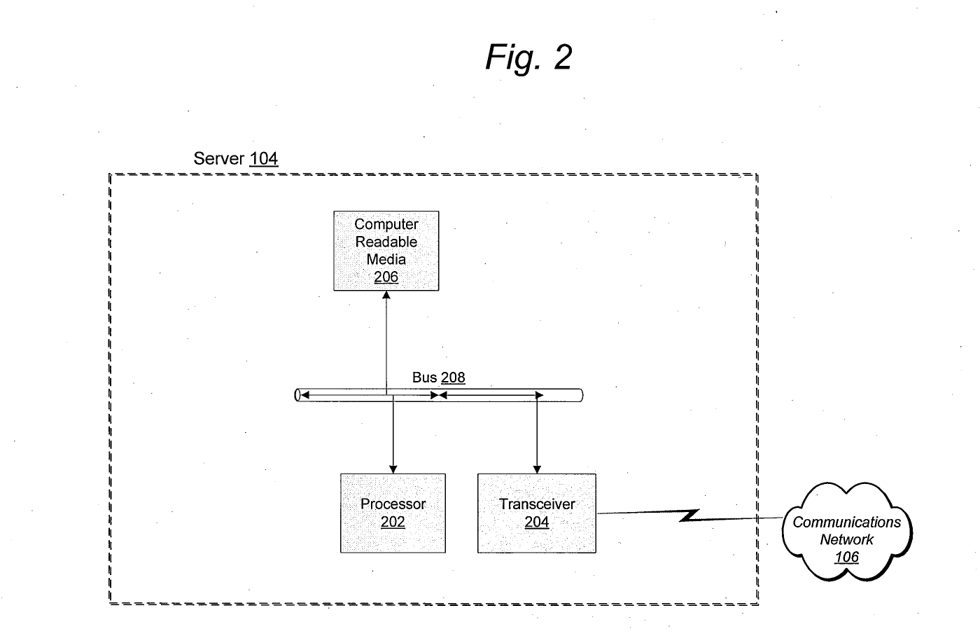

FIG. 2 is an example of a hardware configuration for the software-based extensible lobby services system. The server 104 may be implemented with a number of components connected by a bus 208. A processor 202 may be implemented in hardware, firmware, middleware, software, or any combination thereof. In one embodiment, the processor 202 includes a general purpose processor, such as a microprocessor, capable of supporting multiple software programs. These software programs may perform various functions, such as creating and maintaining the extensible lobby services API for a server 104 and user terminal 102. These software programs may also include applications to support an extensible lobby services system. Those skilled in the art will recognize the interchangeability of hardware, firmware, middleware, and software configurations in either a user terminal or server, and how best to implement the described functionality for each particular application.

The server 104 also includes computer-readable media 206, which provides temporary and/or permanent storage for the software programs used by the processor 202. The computer-readable media 206 may be a stand-alone entity as shown in FIG. 2, or integral to the processor 202, in whole or part. The computer-readable media 206 may include RAM, SRAM, or SDRAM memory, flash memory, ROM memory, EPROM memory, EEPROM memory, registers, hard disk, a removable disk, a CD-ROM, DVD, CD, tape back-up, reel-to-reel, and/or any other form of storage media known in the art. Those skilled in the art will recognize that the term “computer-readable media” includes any type of storage device that is accessible by the processor 202 and also encompasses a carrier wave that encodes a data signal.

Although the hardware layout of FIG. 2 depicts a server 104 as comprising the hardware components 202, 204, 206, and 208, one skilled in the art would appreciate that the representation could just as equally apply to the user terminal 102.

The communications network 106 can be any suitable network including, by way of example, a cellular network or a wireless local area network (LAN) such as Wi-Fi, Wi-Max, or the like. Alternatively, the communications network can be a wide area network (WAN) consisting of routers and public communication lines including leased lines, circuit-switched networks, packet-based networks, and the like. The largest and most well-known example of a WAN is the Internet. The server 104 and user terminal 102 may have a wired or wireless connection. Examples of wired connections include Ethernet systems, DSL, cable modem, fiber optics, standard telephone lines, and others. Examples of wireless connections include cellular systems, wireless LANs, and others.

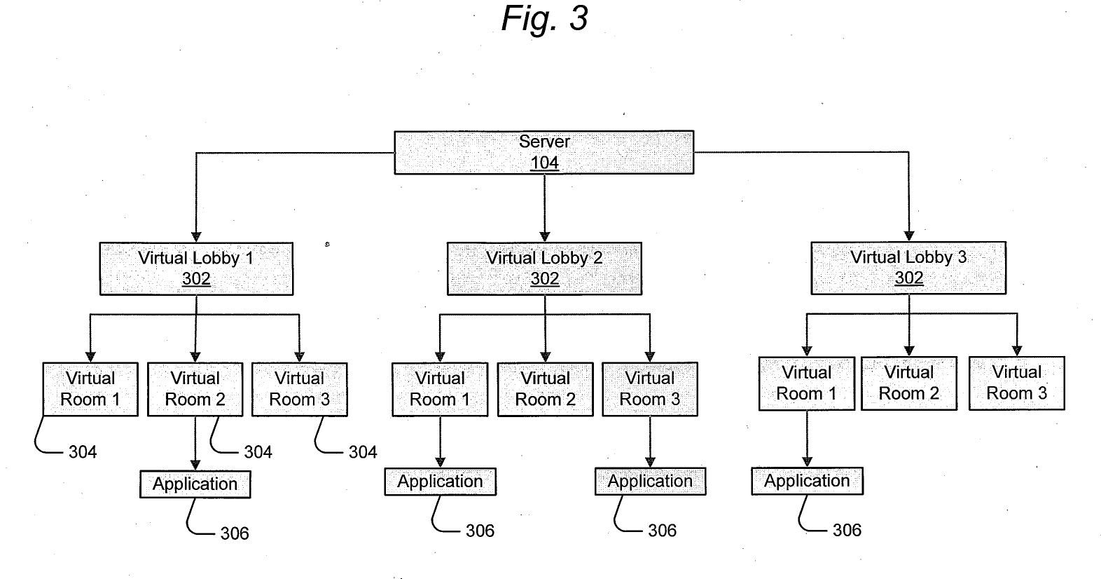

FIG. 3 is a conceptual block diagram illustrating the logical layout of virtual lobbies and their interrelation with virtual rooms and applications. As illustrated, the extensible lobby services system is based around the concept of rooms. Users, via user terminals 102, are matched together into a virtual room 304 from which a common application 306 can be started. Applications 306 may be run from within the room. The rooms 304 themselves are grouped into virtual lobbies 302. Multiple virtual lobbies 302 can be defined for each application 306 running on the server. Each application 306 has a single virtual lobby 302 by default, however, one of ordinary skill in the art can readily appreciate that one can create application specific virtual lobbies 302 to suit their needs. After a user terminal 102 logs into the server 104, virtual lobbies 302 are used to separate users into various groupings, for example, by skill level, by communications network carrier, by application functionality, etc.

Since virtual rooms 304 are organized into virtual lobbies 302, a user must first enter a virtual lobby 302 before entering a virtual room 304 or before using any other room-based lobby services functionality. Further, a user is free to leave and enter virtual lobbies 302 freely, so long as the user meets the specific variables or attributes that are prerequisites to admittance. Also, a user can optionally specify entry criteria of virtual rooms 304 and virtual lobbies 302 from which to search. Once the results are presented to the user, the user can then enter into any room 304 since the results will present only virtual rooms 304 with the variables matching the query.

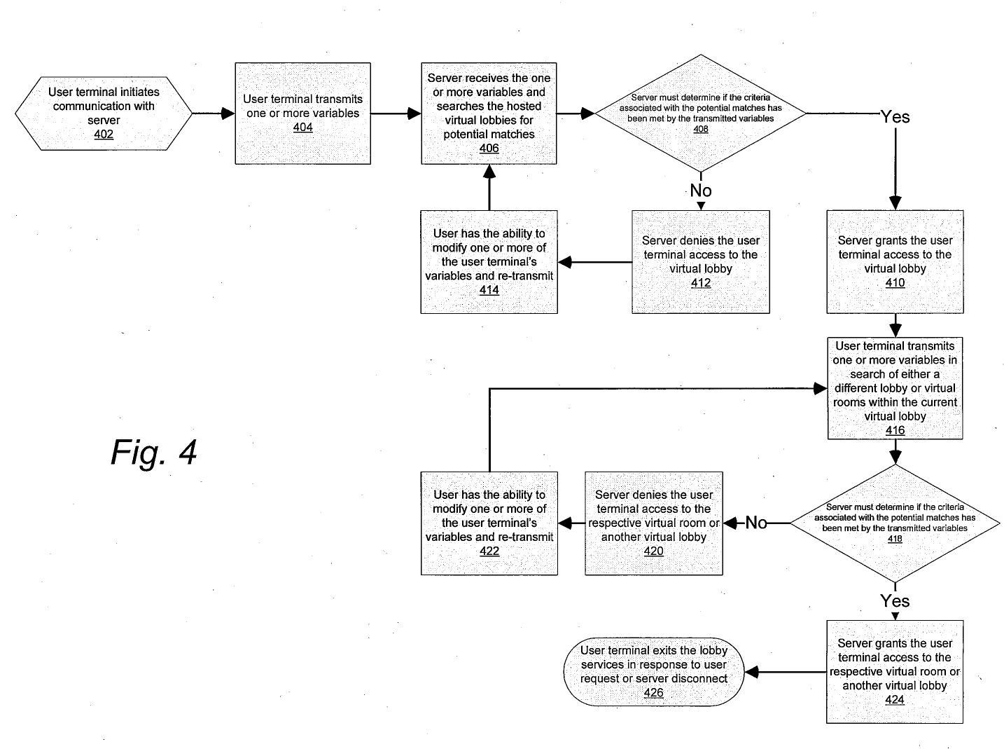

FIG. 4 is a flow chart of an illustrative embodiment of an extensible lobby services system. In step 402, a user terminal 102 initiates a communication session with the server 104 providing lobby services. In step 404, the user terminal 102 sends or otherwise transmits a set of variables, previously defined as including base keys and/or enhanced keys, to the server 104. The server 104 subsequently receives the variables and searches for virtual lobbies 302 that potentially match the runtime criteria in step 406. In step 408, the server 104 must make a determination of whether all the prerequisite criteria are satisfied by the variables received from the user terminal 102. If there is a match, the server 104 grants the user terminal 102 access to the virtual lobby 302 in step 410. Otherwise, in step 412, the server 104 denies the user terminal 102 access to the virtual lobby 302 but allows the user to subsequently modify one or more variables in step 414 and retransmits a successive effort to search for a virtual lobby in step 406.

In step 416, upon having been granted access to the virtual lobby 302, a user terminal 102 has the opportunity to enter, modify, or transmit additional variables in an attempt to search for a different virtual lobby 302 or for a virtual room 304 within the current virtual lobby 302. In step 418, the server 104 must make an additional determination of whether all the prerequisite criteria are satisfied by the additional or modified variables received from the user terminal 102. If there is a match, the server 104 grants the user terminal 102 access to a different virtual lobby 302 in step 424. Otherwise, in step 420, the server 104 denies the user terminal 102 access to another virtual lobby 302 or a virtual room 304 but allows the user to, again, modify one or more variables in step 422 and retransmits a successive effort to search for a different virtual lobby 302 or virtual room 304 in step 416. In step 426, once the need for lobby services has terminated, the user terminal 102 will gracefully exit the virtual room 304 or virtual lobby 302.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A server, comprising:
a transceiver configured to support communications from a user terminal; and
a processor configured to maintain a virtual lobby having one or more variables associated therewith, the processor being further configured to receive from the user terminal one or more variables, and allow the user terminal access to the virtual lobby if each of the one or more variables received from the user terminal match the one or more variables associated with the virtual lobby.

2. The server of claim 1 wherein at least one of the one or more variables associated with the virtual lobby comprises a base key, each of the base keys comprising a runtime value and metadata.

3. The server of claim 2 wherein the one or more of the variables associated with the virtual lobby that are not base keys comprise enhanced keys, each of the enhanced keys comprising a runtime value and metadata.

4. The server of claim 3 wherein the processor is further configured to allow for the modification of the enhanced keys by an application.

5. The server of claim 4 wherein the processor is further configured to read the base keys and the enhanced keys from an XML file.

6. The server of claim 4 wherein the processor is further configured to maintain a virtual room within the virtual lobby, the processor being further configured to receive from the user terminal another one or more variables and allow the user terminal access to the virtual room if said another one or more variables received from the user terminal match one or more variables associated with the virtual room.

7. The server of claim 4 wherein the processor is further configured to maintain at least one more virtual lobby and a plurality of virtual rooms, the processor being further configured to search the virtual lobbies and the virtual rooms for variables matching the one or more variables received from the user terminal.

8. The server of claim 4 wherein the transceiver is further configured to support communications with at least one peer user terminal, the processor being further configured to search at least one peer user terminal for variables matching the one or more variables received from the user terminal.

9. A method for matching users based on at least one of a plurality of configurable variables, comprising:
maintaining a virtual lobby having one or more variables associated therewith;
receiving from a user terminal one or more variables; and
allowing the user terminal access to the virtual lobby if the one or more variables received from the user terminal match the one or more variables associated with the virtual lobby.

10. The method of claim 9 wherein the maintenance of a virtual lobby comprises generating at least one base key, each of the base keys comprising a runtime value and metadata.

11. The method of claim 10 wherein the maintenance of a virtual lobby comprises generating at least one enhanced key, each of the enhanced keys comprising a runtime value and metadata.

12. The method of claim 11 wherein the generation of each of the enhanced keys further comprises modifying each the enhanced keys.

13. The method of claim 12 wherein the maintenance of a virtual lobby further comprises reading the base keys and the enhanced keys from an XML file.

14. The method of claim 13 wherein the receiving from the user terminal further comprises receiving another one or more variables and allowing the user terminal access to a virtual room within the virtual lobby if said another one or more variables received from the user terminal match one or more variables associated with the virtual room.

15. The method of claim 14 further comprising maintaining at least one more virtual lobby and at least one more virtual room, and searching the virtual lobbies and the virtual rooms for variables matching the one or more variables received from the user terminal.

16. The method of claim 15 further comprising supporting communications between the user terminal and at least one peer user terminal, and searching the peer user terminals for variables matching the one or more variable received from the user terminal.

17. A server, comprising:
means for communicating with a user terminal;
means for maintaining a virtual lobby having one or more variables associated therewith;
means for receiving from the user terminal one or more variables; and
means for allowing a user terminal access to the virtual lobby if the one or more variables received from the user terminal match the one or more variables associated with the virtual lobby.

18. The server of claim 17 further comprising means for generating at least one base key, each of the base keys comprising a runtime value and metadata.

19. The server of claim 18 further comprising means for generating at least one enhanced key, each of the enhanced keys comprising a runtime value and metadata.

20. The server of claim 19 further comprising means for reading the base keys and the enhanced keys from an XML file.

21. The server of claim 19 further comprising means for receiving another one or more variables and allowing the user terminal access to a virtual room within the virtual lobby if said another one or more variables received from the user terminal match one or more variables associated with the virtual room.

22. The server of claim 21 further comprising means for maintaining at least one more virtual lobby and at least one more virtual room, and searching the virtual lobbies and the virtual rooms for variables matching the one or more variables received from the user terminal.

23. The server of claim 22 further comprising means for supporting communications between the user terminal and at least one peer user terminal, and searching the peer user terminals for variables matching the one or more variable received from the user terminal.

24. A computer readable medium embodying a program of instructions executable by a processor in a server, the server being configured to receive from a user terminal one or more variables, the instructions comprising:
code to maintain a virtual lobby; and
code to allow the user terminal access to the virtual lobby if the one or more variables received from the user terminal matches one or more variables associated with the virtual lobby.

25. The computer readable medium of claim 24 further comprising code to receive another one or more variables and allow the user terminal access to a virtual room within the virtual lobby if said another one or more variables received from the user terminal match one or more variables associated with the virtual room.

26. The computer readable medium of claim 25 further comprising code to maintain at least one more virtual lobby and at least one more virtual room, and search the virtual lobbies and the virtual rooms for variables matching the one or more variables received from the user terminal.

27. The computer readable medium of claim 26 further comprising code to support communications between the user terminal and at least one peer user terminal, and search the peer user terminals for variables matching the one or more variable received from the user terminal.
